(19) United States
(12) Patent Application Publication
(10) Pub. No.: US 2022/0144291 A1
(43) Pub. Date: May 12, 2022

(54) PORTABLE WIRELESS CONNECTED DIAGNOSTIC SYSTEM FOR A VEHICLE

(71) Applicant: TVS MOTOR COMPANY LIMITED, Chennai (IN)

(72) Inventors: Arpan Guha, Chennai (IN); Sampigehalli Narayanappa Mokshith, Chennai (IN); Chetan Kumar Gupta, Chennai (IN); Pradeep Bhatt, Chennai (IN); Rajendra Bhat, Chennai (IN)

(73) Assignee: TVS MOTOR COMPANY LIMITED, Chennai (IN)

(21) Appl. No.: 17/436,407

(22) PCT Filed: Mar. 5, 2020
(86) PCT No.: PCT/IN2020/050198

§ 371 Date: Sep. 3, 2021

(30) Foreign Application Priority Data
Mar. 15, 2019 (IN) 201941010134

(51) Int. Cl. B60W 50/00; G07C 5/00; B60R 16/023; G07C 5/08

(52) U.S. Cl. CPC B60W 50/00; G07C 5/008; B60R 16/0231; H04W 4/80; G07C 2205/02; B60W 2050/0083; G07C 5/0825

(57) ABSTRACT

A diagnostic system for a vehicle includes: a portable wireless handheld diagnostic device which is capable of sending data through wireless mode and receiving data through wireless mode; a vehicle communication interface (VCI) which interfaces between the portable wireless handheld diagnostic device and the vehicle for communicating parameters of the vehicle to the portable wireless handheld diagnostic device; and a coupler including a first port which connects to the vehicle through an in-vehicle network and a second port which connects to the vehicle communication interface (VCI). The VCI includes a vehicle data-collection and transmission component that supports communication software which collects diagnostic data from a vehicle electronic control unit (ECU) and transmits data to the vehicle ECU. The vehicle communication interface (VCI) device includes a separate internal storage device preloaded with a micro kernel which is capable of executing specific subroutines in a standalone manner.

### TECHNICAL FIELD

The present subject matter relates to a diagnostic system for a vehicle and more particularly to a vehicle communication interface (VCI) device which interfaces between a diagnostic tool and the vehicle.

### BACKGROUND

A diagnostic tool is used for connecting to a vehicle's ECU (Electronic control unit) to check various parameters of a vehicle and to assess their values are in a prescribed limit according to specification of the vehicle. In case there exists any abnormality in any of the parameters of the vehicle, the diagnostic tool detects those parameters and helps the technician by highlighting those issues so that the technicians can resolve those issues. Existing diagnostic tools used by OEMs (Original equipment manufacturers) are handheld standalone units which needs to be connected to a computer to perform part of their functions.

Though the diagnostic tool performs data acquisition from the vehicle, there is a limited or no scope of providing solutions like guided trouble shooting, integration with dealership management systems, etc.

The devices are proprietary to their manufacturers and do not allow for easy upgrades and changes either to device or vehicle which leads to increased cost of ownership and maintenance. Thus, there is a need for an improved diagnostic system which overcomes all the above explained problems & other problems in known art.

### BRIEF DESCRIPTION OF DRAWING

Drawings given below are provided to support the description of the invention and are not limiting the scope of the present invention.

FIG. 1 illustrates proposed OEM diagnostic solution.

FIG. 2 illustrates interfaces and communication channels of the proposed OEM diagnostic solution

FIG. 3 illustrates steps of programming the micro kernel.

FIG. 4 illustrates method of updating of micro kernel in multiple vehicles.

FIG. 5 illustrates integration of Dealership Management System with the proposed OEM diagnostic solution for guided troubleshooting.

FIG. 6 illustrates integration of the proposed OEM diagnostic solution for guided troubleshooting.

### DETAILED DESCRIPTION OF THE INVENTION

The present invention will become more fully understood from the detailed description given herein below and the accompanying drawing(s). The drawings provided herein incorporate and constitute embodiments of the invention and illustrate several aspects of the invention and together with a description of the embodiments serve to explain the principles of the invention.

Existing diagnostic tools used by OEMs (Original equipment manufacturers) are handheld standalone units which needs to be connected to a computer to perform part of their functions. Which involves considerable wiring harness and power connections which further restricts the mobility of the devices surrounding the vehicle. In such a diagnostic tool, the support of communication protocols is limited and is generally not modifiable without changing the hardware. Thus, if there is a need of new communication protocol, the whole standalone hardware requires to be changed thus resulting into extra cost.

Current wired communication creates hazard of tripping over in workshop environment. A wired connection requires VCI to have an extra physical port thus increasing cost and chances of wear. Internal failure of wired connection may cause spurious/wrong information being transmitted between VCI and computer. Multiple VCI usage in high volume on the service end at dealership requires removal and re-fit of cable resulting in increased service time and wearing off of the communication port of VCI connected to the wired computer.

In such a system, performing vehicle software upgrades/changes requires tool to simultaneously connect to computer and vehicle due to which a lot of time is consumed for software upgradation/changes at the vehicle end. Also, VCI to vehicle communication also involves technical limitations such as requirement of different proprietary coupler for different products, direct connection of VCI to vehicle port wears out the communication port of VCI connected to the vehicle during multiple removal and reconnection thus resulting into replacement of complete VCI module.

The wired VCI lacks support for multiple protocols. Further, hardware or firmware change is required for base communication protocol change. The diagnostic application software resides on the hand held device only and cannot be migrated to different hardware in case of breakdown of hardware. The wired hand held devices have limited memory which requires frequent erasing of locally stored diagnostic data or connecting to computer for saving the data. Furthermore, the wired hand held devices require high power while operating either from separate external power source or from vehicle battery, thereby draining vehicle battery to non-starting levels in a short time of continuous usage. Further in such a VCI if a sub routine needs updation or a change, the whole VCI needs to be formatted and re-flashed/re-programmed which requires extra time and effort. Diagnostic trouble codes (DTC) inside the prior art wired hand held diagnostic devices have only short codes which is difficult to understand. The prior art wired hand held tools if stolen are not possible to be tracked or disabled and could be used for reverse engineering. Further, Prior art hand held tools have no traceability or linking of DTC's identified and jobs performed with dealership management system (DMS).

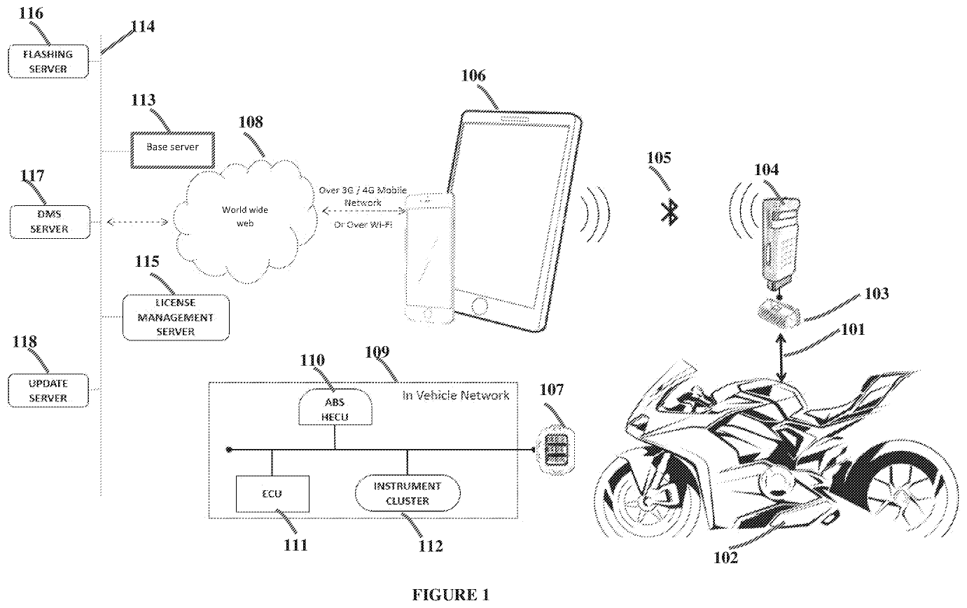

FIG. 1 illustrates a portable wireless connected diagnostic system for vehicle as per an embodiment of the present subject matter. It comprises of a vehicle 102 to be diagnosed, a coupler 103 which is an OBD DLC (on-board diagnostic data link connector), a cable 101, a vehicle communication interface (VCI) 104, a first wireless communication channel 105, portable wireless handheld diagnostic device 106 communicating on world wide web/cloud/server/internet or the like. For ease of reference, the words cloud, server, internet, world wide web is used interchangeably across the specification. The coupler 103 comprises of a vehicle diagnostic port which connects to the vehicle 102 and the OBD side port which connects to the vehicle communication interface (VCI) 104. The coupler 103 as per an embodiment has a 16 pin OBD side port which connects to the vehicle communication interface (VCI) 104 and a diagnostic port with 6 pin coupler which connects to the vehicle 102. The diagnostic port coupler 107 interacts with the in-vehicle network 109. The in-vehicle network further comprises of an ECU 111, an ABS Hydraulic Electronic Control Unit (HECU) 110 and an instrument cluster 112 or the like.

The vehicle communication interface 104 utilizes the first wireless communication channel 105 to communicate with the portable wireless handheld diagnostic device 106. As per an embodiment, the first wireless communication channel 105 is preferably a Bluetooth communication channel. The portable wireless handheld diagnostic device 106 further is further connected to the world wide web/internet 108 using a second communication channel. The second communication channel is preferably a Wi-Fi or a 3G/4G/5G network. The connection of the portable wireless handheld device 106 to the world wide web/108 further provides access to an OEM network 114 which hosts the base server 113, license management server 115, flashing server 116, DMS server 117 and an update server 118.

According to another embodiment of the present invention, re-programming ECU of vehicle through VCI or through mobile devices via VCI results into a fast and easy flashing of the ECU. In yet another embodiment of the present invention a One Time Password can be provided for controlled secured access for writing and flashing functions. In one embodiment of the present invention individually addressable address is provided to portable wireless handheld diagnostic device based on VCI MAC address. The VCI provides an extensible architecture to integrate and customize with existing IT solutions. The present invention further facilitates centralized ECU data management for vehicle OEM and dealership and system update over the air.

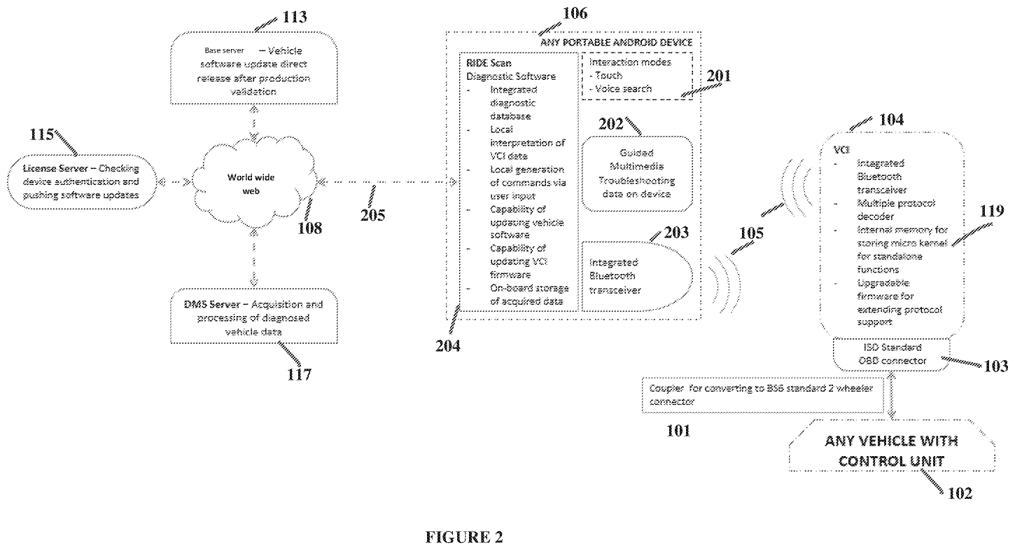

FIG. 2 illustrates a conversion cable 101 for coupling standard VCI to any other vehicle's ECU, a vehicle 102, a OBD DLC coupler 103, vehicle communication interface 104, wireless communication channel 105, portable wireless handheld device 106, base server 113, license management server 115, DMS server 117, Interaction modes 201, guided troubleshooting data on device 202, Integrated transceiver 203, Portable wireless handheld diagnostic device 106 204, second wireless communication channel 205.

The VCI 104 according to one embodiment of our present invention comprises of a separate internal memory for storing a micro-kernel (119) for standalone functions which allows to execute a software update of a vehicle software just by plugging the VCI to a vehicle without need for connecting the VCI to the diagnostic device 106. This eliminates requirement to re-flash the entire memory of the VCI for changing a sub routine. Further, recording of vehicle's parameters is quicker due to the separate memory for micro kernel. In one embodiment of the present invention, the coupler 103 interfaces OBD side port to diagnostic port and is used in between VCI and vehicle for communication between VCI 104 and the vehicle 102 to enable replacement of worn out extra coupler during extended use which further eliminates the requirement of substitution of high cost VCI 104 in case the coupler of VCI 104 gets damaged due to extended use by way of insertion and removal. The vehicle communication interface unit establishes communication between portable wireless handheld diagnostic device 106 and vehicle. The VCI unit converts and transceives vehicle data to wirelessly transmissible format. VCI 104 consists of a vehicle data-collection and transmission component that supports communication software which collects diagnostic data from the vehicle computer and is also able to transmit data to the vehicle computer and is capable of modifying the software inside the vehicle. VCI 104 also consists of a data-transmission component, in electrical communication with the vehicle data-collection and transmission electronics within the VCI configured to transmit an outgoing data packet comprising the diagnostic data over a wireless link and receive over the same link an incoming data packet that modifies the communication software and can be transmitted through the wireless link to the vehicle computer thereby modifying the in-vehicle software; and a separate internal storage device preloaded with a micro kernel which is capable of executing specific subroutines without connection with the portable wireless handheld diagnostic device 106 autonomously, once the VCI 104 is programmed. A separate memory for micro kernel avoids re-writing of entire micro kernel programming for a sub routine upgradation/change. The updation/change of sub routine is faster when a separate memory for micro kernel is used.

In one embodiment of the present invention, ISO standard OBD side portion OBD data link connector is used in VCI to ensure commonality of parts. Wearing off of VCI port due to direct connection of VCI to vehicle port during multiple removal and reconnection is avoided. Hence, to avoid the above problem of wearing off of the VCI port, according to one embodiment of the present invention, an extra coupler used in between VCI and vehicle for converting OBD side port on coupler to vehicle diagnostic port ensuring connectivity to vehicle. Thus, on wear-out of coupler connector during extended use, only coupler replacement is required thus thereby reducing the cost of maintenance and replacement.

Further, the VCI according to one embodiment of our invention draws considerably lesser current approximately 100 mA while operating and less than 1 mA at 12V DC in sleep mode and has very miniscule impact on vehicle battery level.

The portable wireless handheld diagnostic device 106 consists of a plurality of methods of diagnosing vehicle status through data acquisition, processing & monitoring of various vehicular parameters which can be accessed using a handheld and wireless computing device such as a smartphone or a tablet. In one embodiment of the present invention, the handheld and wireless computing device is based on an Android platform/operating system. The methods of diagnosing vehicle status include functions of receiving the outgoing data packet from the wireless link with VCI 104, process the data packet to generate a set of vehicle diagnostic data and display the data in a human readable manner, communicate on the Internet to a remote computer to check for updates of vehicle software, authentication of device, send out the received data over world wide web/world wide web/internet to DMS server 117, send out the incoming data packet over the wireless link with VCI 104 to modify the communication and/or the vehicle software and show step by step multimedia guides based on the identified vehicle issues aiding the technician/service personnel.

Integration of diagnostic device 106 with Dealer Management Server (DMS) 117 through world wide web/internet 108 helps in spare parts/parts monitoring at the vehicle, the dealership end and the spare parts stock at the factory where the spare parts are produced.

The present portable wireless handheld diagnostic device 106 is capable of providing an integrated diagnostic trouble codes description database with translation in multiple regional languages like Hindi, Tamil, etc. which can be understood by various service technicians of different geographical regions and various languages thus provides increased accuracy and timeliness of diagnosis of the vehicular parameters.

In the proposed portable wireless handheld diagnostic device 106, the diagnostic method checks for authorization over world wide web/internet can be provided for every pre-determined number of diagnostic sessions and can also be used for management of authentication for licensing purposes. In one embodiment of the present invention a mechanism to lock unauthorized usage of the portable wireless handheld diagnostic device 106 is provided.

A job card is a record that includes vehicle's chassis number, engine number, registration details, owner's details, problems faced during the operation of the vehicle etc. The proposed portable wireless handheld diagnostic device 106 has the capability wherein the diagnostic session can be linked to individual vehicle job-card generated by DMS allowing storage of faults identified, repair actions taken from portable wireless handheld diagnostic device 106 to DMS system allowing traceability of customer's vehicle repair history.

The diagnostic toll is configured to run on any android device i.e. smart phone, tablet, chrome-book, etc. This feature allows further modification of process without changing hardware. Further, wireless communication with vehicle avoids hazard of tripping over in workshop environment. Ease of use and high mobility is achieved in a workshop environment. Using a handheld and wireless computing device such as a smartphone or a tablet running on an Android platform provides device interchangeability and ease of migration by only installation of an application on the device.

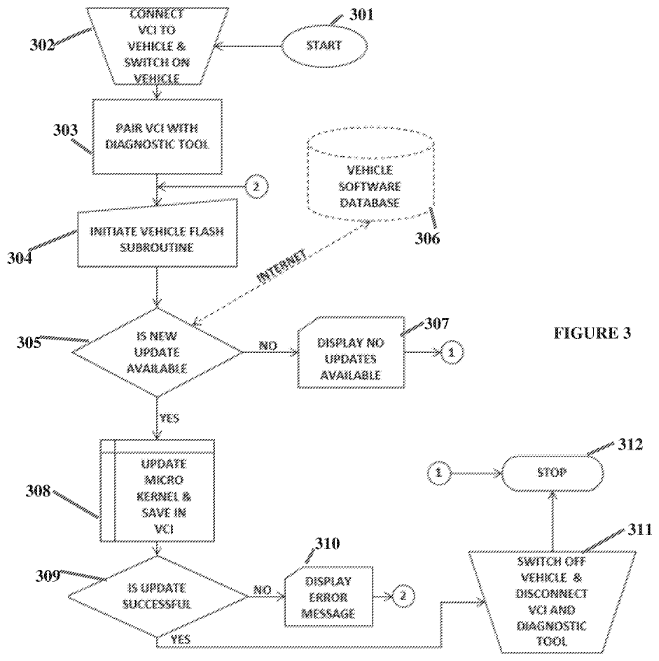

FIG. 3 illustrates method of programming the micro kernel. For programming the micro kernel, at step 302 the vehicle is connected to the VCI 104 and once the VCI is firmly connected to the vehicle, the vehicle is switched ON so that the VCI 104 can communicate to the vehicle ECU 111. At step 303, the VCI 104 is paired with the portable wireless handheld diagnostic device 106 which is required for mutual identification of the VCI 104 and the portable wireless handheld diagnostic device 106 with each other. At step 304, vehicle's ECU's flashing sub routine is initiated. Once initiated, at step 305, the portable wireless handheld diagnostic device 106 communicates with a vehicle software database 306 to check for availability of any new update for the vehicle software. If there are no updates available, the portable wireless handheld diagnostic device 106 displays a message “No updates available”. In case an update is available, the sub routine is updated in the micro kernel and saved in the separate memory for micro kernel in the VCI 104. If the updation of micro kernel's subroutine in the VCI 104 is successful, a message displays “Update successful” after which the vehicle is switched OFF and the VCI and the portable wireless handheld diagnostic device 106 are disconnected. If updation of micro kernel's subroutine in the VCI 104 has failed, a message displays “Update failed” and again the step 304 is followed.

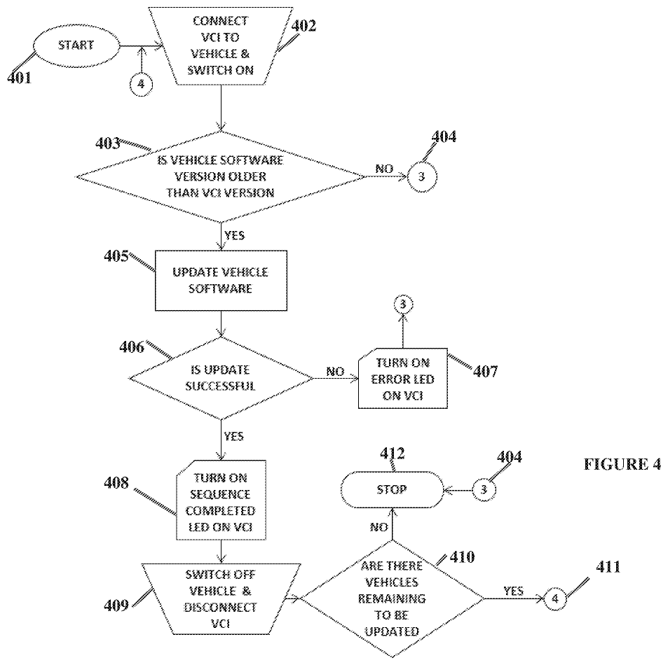

FIG. 4 illustrates method for updating multiple vehicles. At step 402, the vehicle is connected to the VCI 104 and once the VCI is firmly connected to the vehicle, the vehicle is switched ON so that the VCI 104 can communicate to the vehicle ECU 111. At step 403, it is checked whether the vehicle ECU's software version is older that the software stored in the VCI 104. If “NO”, then updating of vehicle's software is stopped. If it is found that the vehicle ECU's software version is indeed older that the software stored in the VCI 104, the vehicle's ECU's software is updated. Once the vehicle's ECU's software update is not successful, an ERROR message at step 407 is generated. If the vehicle's ECU's software update is successful, a sequence completion LED on VCI 104 is turned ON at step 408. In the next step 409, the vehicle is switched OFF and the VCI is disconnected from the VCI 104. In the next step 410, it is checked if there are more vehicles available wherein the software update is required/to be checked. If there are no more vehicles, the process is stopped or else the step 402 is followed again for the available vehicle.

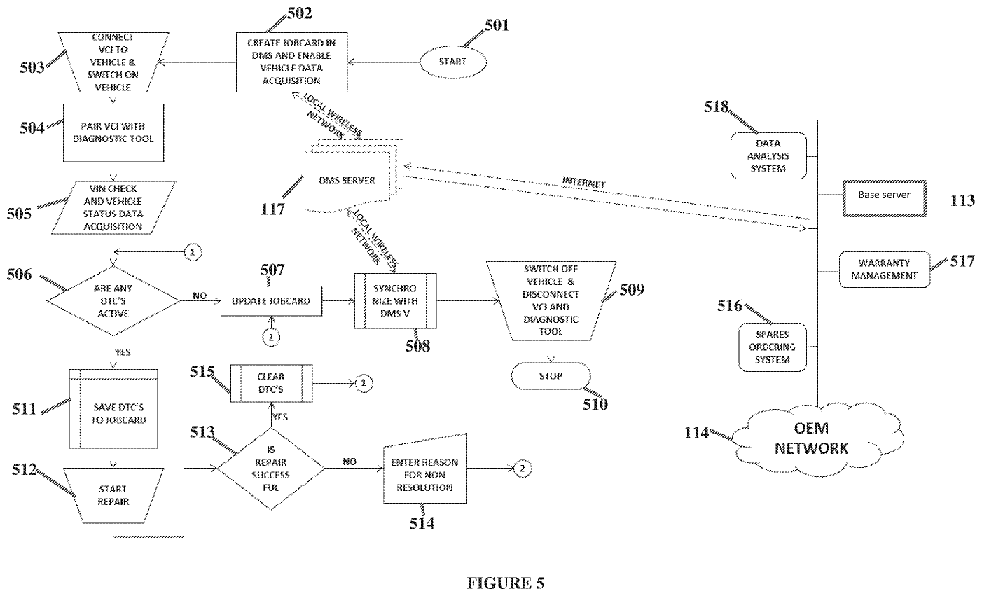

FIG. 5 illustrates integration of dealer management system (DMS) 117 with the vehicle and the portable wireless handheld diagnostic device 106. At the step 502, a job card is created in the DMS 117 and the DMS server is made ready for data acquisition from the vehicle. Once the job card is ready, the vehicle is connected to the VCI 104 and once the VCI is firmly connected to the vehicle, the vehicle is switched ON so that the VCI 104 can communicate to the vehicle ECU 111. At step 504, the VCI 104 is paired with the portable wireless handheld diagnostic device 106 which is required for mutual identification of the VCI 104 and the portable wireless handheld diagnostic device 106 with each other. At the next step 505, the VIN (Vehicle Identification Number) is checked and if the VIN number is authenticated, data acquisition starts from the vehicle to the portable wireless handheld diagnostic device 106. Once the data acquisition is completed, the portable wireless handheld diagnostic device 106 for all/any of the diagnostic trouble codes (DTC's), the DTCs are updated in the job card. If no diagnostic trouble codes (DTC's) are detected, the same is updated in the job card at step 507. The content of the job cards is synchronized with the DMS server 117 at the step 508. The DMS server 117 communicates with the vehicle for vehicle data acquisition and at the same the DMS server 117 also communicates with the OEM network 114 containing the spares ordering system 516, warranty management system 517, base server 113 and the data analysis system 518. Once the data between the vehicle ECU 111 and the DMS server 117 is synchronized, the vehicle is switched OFF and disconnected from the VCI 104 and the portable wireless handheld diagnostic device 106. In case any DTC's are found at the step 506, the DTC's are saved into the job card at step 511. At step 512, the repair of the vehicle starts in accordance with the guided troubleshooting procedures taking each DTC one by one. Once the repair is successful at step 513, that particular DTC is cleared at step 515 and the system again checks for any other available DTC at step 506 and thereby again the steps 507, 508, 509, 510, 117 and the steps 511, 512, 513, 514, 515 are followed. Also, in cases wherein any problem associated with any of the DTCs is not resolved, a reason for non-resolution of the DTC shall be entered in the job card 507.

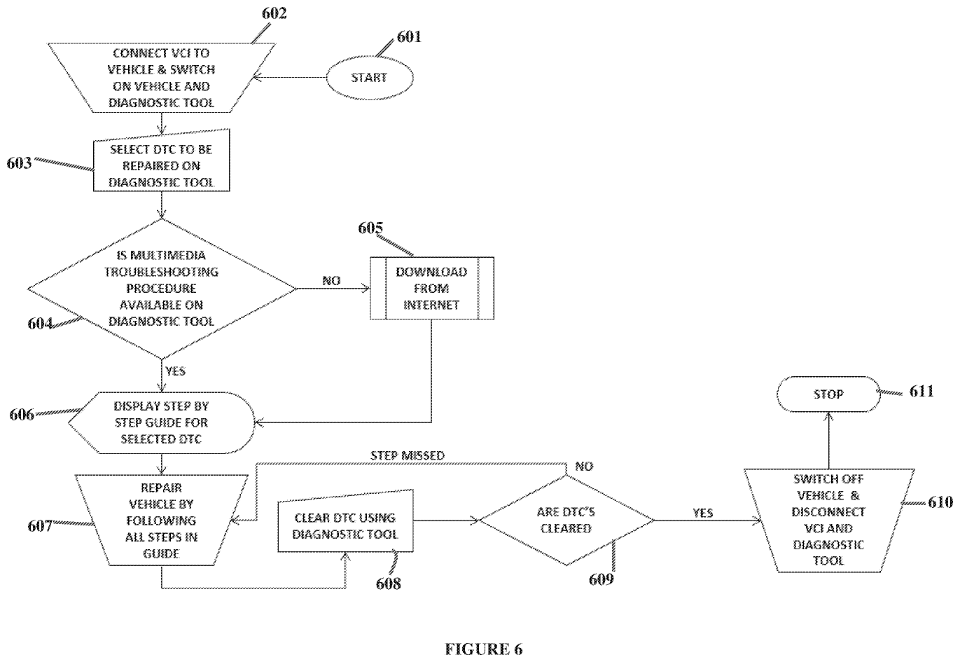

FIG. 6 illustrates the method of performing guided troubleshooting based on the present portable wireless connected diagnostic system for the vehicle. At step 602, the vehicle is connected to the VCI 104 and once the VCI is firmly connected to the vehicle, the vehicle is switched ON so that the VCI 104 can communicate to the vehicle ECU 111. At step 603, the DTC's are selected to be repaired using the portable wireless handheld diagnostic device 106. In the next step 604, availability of the multimedia troubleshooting procedure on the portable wireless handheld diagnostic device 106 is checked for the encountered DTC. If the multimedia troubleshooting procedure is not available on the portable wireless handheld diagnostic device 106, the multimedia troubleshooting procedure is downloaded through the world wide web/internet 108 at step 605 from the OEM network 114. Once the multimedia troubleshooting procedure is located corresponding to the DTC encountered, the step by step guiding for repairing of the vehicle is displayed at step 606 on the portable wireless handheld diagnostic device 106. Once the repair of the vehicle has been performed according to the multimedia troubleshooting procedure at step 607, the corresponding DTC is cleared at step 608. If any further DTC is open for repair checked at step 609, then step 606 is followed for that DTC until repair has been performed for all the encountered DTC's. Once all the DTCs are cleared, the vehicle is switched OFF and the portable wireless handheld diagnostic device 106 and the VCI 104 are disconnected. Still if any DTC's are left, again the step 607 for repairing by following all steps in the multimedia guide is carried out for the missed DTCs.

The present portable wireless connected handheld diagnostic system for the vehicle as per an embodiment supports ISO 14229, ISO 15765, KWP2000 ISO 14230/9141-2 (K Line), J1850 VPW/PWM, DoIP and CAN FD, ISO 9141, SCI, and Dual wire CAN natively and by software upgrade.

A diagnostic method for a vehicle (102) according to one embodiment of the present invention comprises steps of: connecting VCI to vehicle thereafter switching ON the vehicle; pairing VCI with a diagnostic tool; initiating vehicle flash subroutine; checking availability of an update; saving subroutines to be updated in a micro kernel within VCI; updating specific sub routines through vehicle ECU; checking if the update is successful; displaying error message on unsuccessful update, displaying update successful for a successful update, switching OFF the vehicle and disconnecting VCI and diagnostic tool. The diagnostic method for a vehicle (102) includes a step wherein a job card is created on connecting VCI to vehicle after switching ON the vehicle wherein the job card includes vehicle information data. The vehicle information data includes vehicle engine number, vehicle chassis number, status of sensors. The vehicle information data is communicated to a dealer management server (117) and spare ordering system (516) on real time basis.

According to yet another embodiment of the present invention, a guided diagnostic method for a vehicle (102) comprises steps of connecting VCI (104) to vehicle thereafter switching ON the vehicles; selection of diagnostic trouble code (603) on diagnostic tool; checking if the multimedia troubleshooting procedure is available on diagnostic tool (604); if multimedia troubleshooting procedure is available on diagnostic tool, step by step guide for clearing diagnostic trouble code (606) is displayed on a display unit; if multimedia troubleshooting procedure is not available on diagnostic tool, diagnostic trouble code is download from internet (605); vehicle is repaired by following all steps in guide (607); diagnostic trouble code is cleared and checked for next diagnostic trouble code (608, 609); check is done for all diagnostic trouble codes are cleared (609); once all diagnostic codes are cleared, switching OFF the vehicle (610); disconnecting VCI and diagnostic tool.

The embodiments disclosed above are not intended to be exhaustive or to limit the present invention to the precise forms disclosed in the following detailed description. Rather, the embodiments are chosen and described so that best enabling arrangements of the invention can be explained through all possible embodiments and examples of it. The invention may have application to all kind of vehicles.

1.-22. (canceled)

23. A diagnostic system for a vehicle, the diagnostic system comprising:
a portable wireless handheld diagnostic device which is capable of sending data through wireless mode and receiving data through wireless mode;
a vehicle communication interface (VCI) which interfaces between the portable wireless handheld diagnostic device and the vehicle for communicating parameters of the vehicle to the portable wireless handheld diagnostic device; and
a coupler comprising of a first port which connects to the vehicle through an in-vehicle network and a second port which connects to the vehicle communication interface (VCI); wherein
the VCI comprises a vehicle data-collection and transmission component that supports communication software which collects diagnostic data from a vehicle electronic control unit (ECU) and transmits data to the vehicle ECU; and
the vehicle communication interface (VCI) device comprises a separate internal storage device preloaded with a micro kernel which is capable of executing specific subroutines in a standalone manner.

24. The diagnostic system in claim 23, wherein the coupler is detachably attached to the VCI.

25. The diagnostic system in claim 23, wherein update and change in a subroutine is performed within the separate internal storage device for the micro kernel.

26. The diagnostic system in claim 23, wherein the micro kernel is capable of executing specific subroutines without physical connection with the portable wireless handheld diagnostic device.

27. The diagnostic system in claim 23, wherein the first port of coupler is a 16-pin port which connects to the VCI and the second port is a 6-pin port which connects to the vehicle.

28. The diagnostic system in claim 23, wherein an individually addressable address is configured to the portable wireless handheld diagnostic device based on a VCI MAC (Media Access Control) address.

29. The diagnostic system in claim 23, wherein the portable wireless handheld diagnostic device is a standalone wireless device.

30. The diagnostic system in claim 23, wherein the portable wireless handheld diagnostic device communicates with the VCI through a wireless communication channel.

31. The diagnostic system in claim 30, wherein the wireless communication channel is a Bluetooth connection.

32. The diagnostic system in claim 23, wherein the in-vehicle network comprises at least one vehicle controller unit.

33. The diagnostic system in claim 32, wherein the vehicle controller unit includes the ECU, an ABS Hydraulic Electronic Control Unit (HECU), and an instrument cluster.

34. The diagnostic system in claim 23, wherein the ECU communicates with an instrument cluster through an in-vehicle network.

35. The diagnostic system in claim 23, wherein the data from the in-vehicle network, which includes at least one vehicle controller unit, is sent to a diagnostic port coupler.

36. The diagnostic system in claim 23, wherein data from the ECU, an ABS Hydraulic Electronic Control Unit (HECU), and an instrument cluster is sent to a diagnostic port coupler.

37. The diagnostic system in claim 32, wherein re-programming of the at least one vehicle controller unit is done through the VCI.

38. The diagnostic system in claim 33, wherein re-programming of the ECU, the ABS Hydraulic Electronic Control Unit (HECU), and the instrument cluster is done through the VCI.

39. A diagnostic method for a vehicle, the diagnostic method comprises:
connecting a vehicle communication interface (VCI) to the vehicle after switching ON the vehicle;
pairing the VCI with a diagnostic tool;
initiating vehicle flash subroutine;
checking availability of an update;
saving subroutines to be updated in a micro kernel within the VCI;
updating specific subroutines through a vehicle ECU;
checking if the update is successful;
displaying an error message on an unsuccessful update;
displaying update successful for a successful update;
switching OFF the vehicle; and
disconnecting the VCI and the diagnostic tool.

40. The diagnostic method in claim 39, wherein a job card is created on connecting the VCI to the vehicle after switching ON the vehicle.

41. The diagnostic method in claim 40, wherein the job card includes a vehicle information data.

42. The diagnostic method in claim 41, wherein the vehicle information data includes a vehicle engine number, a vehicle chassis number, and a status of sensors.

43. The diagnostic method in claim 42, wherein the vehicle information data is communicated to a dealer management server and spare ordering system on real time basis.

44. A guided diagnostic method for a vehicle, the guided diagnostic method comprises:
connecting a vehicle communication interface (VCI) to the vehicle after switching ON the vehicle;
selection of a diagnostic trouble code on a diagnostic tool;
checking if a multimedia troubleshooting procedure is available on the diagnostic tool, if the multimedia troubleshooting procedure is available on the diagnostic tool, display a step by step guide for clearing the diagnostic trouble code, and if the multimedia troubleshooting procedure is not available on the diagnostic tool, download the diagnostic trouble code from internet;
repairing the vehicle by following the step by step guide;
clearing the diagnostic trouble code and check for a next diagnostic trouble code;
checking if all diagnostic trouble codes are cleared;
switching OFF the vehicle; and
disconnecting the VCI and the diagnostic tool.
